(19) United States
(12) Patent Application Publication
(10) Pub. No.: US 2018/0231878 A1
(43) Pub. Date: Aug. 16, 2018

(54) PROJECTION APPARATUS AND THERMAL TRANSFER MODULE

(71) Applicant: Coretronic Corporation, Hsin-Chu (TW)

(72) Inventors: Chun-Ting Lin, Hsin-Chu (TW); Wen-Yen Chung, Hsin-Chu (TW); Tsung-Ching Lin, Hsin-Chu (TW)

(73) Assignee: Coretronic Corporation, Hsin-Chu (TW)

(21) Appl. No.: 15/893,677

(22) Filed: Feb. 11, 2018

(30) Foreign Application Priority Data
Feb. 14, 2017 (CN) 201710077945.7

(51) Int. Cl. G03B 21/16

(52) U.S. Cl. CPC G03B 21/16

(57) ABSTRACT

A projection apparatus includes a housing and at least one thermal transfer module. The housing includes at least one air inlet and at least one air outlet. The thermal transfer module includes a flow-guiding structure, at least one fan, and at least one heat source. The flow-guiding structure is configured in the housing, and connected between the air inlet and the air outlet to form a flow channel. The fan is configured in the flow channel. The heat source is configured in the flow channel, and is at least partially located between the fan and air outlet. The invention further relates to a thermal transfer module. A thermal transfer module is also provided. The projection apparatus and the thermal transfer module can lower noise generated by a fan, and have good heat dissipation efficiency.

### CROSS-REFERENCE TO RELATED APPLICATION

This application claims the priority benefit of China application serial no. 201710077945.7, filed on Feb. 14, 2017. The entirety of the above-mentioned patent application is hereby incorporated by reference herein and made a part of this specification.

### BACKGROUND OF THE INVENTION

### 1. Field of the Invention

The invention relates to a projection apparatus and a thermal transfer module, and in particular, to a projection apparatus and a thermal transfer module that has a flow-guiding structure.

### 2. Description of Related Art

A projection apparatus is a display apparatus for generating a large-sized image. An imaging principle of the projection apparatus is to covert, by using a light valve, an illumination beam generated by a light source into an image beam, and then project, by using a camera, the image beam onto a display screen or a wall surface. Because in an optical engine of the projection apparatus, heat is generated when a component such as the light source, the light valve, or a phosphor wheel is operated, a fan needs to be mounted, so as to provide forced convection by using the fan to dissipate heat of these components.

With advancement of projection technologies, a user has higher demand on high-luminance and low-noise of the projection apparatus. Generally. Higher luminance of the light source of the projection apparatus indicates more heat generated by the light source. If rotating speed of the fan is correspondingly increased to enforce a heat dissipation airflow, the fan located at an air outlet of a housing of the apparatus generates excessively loud noise, and the noise is transferred to an exterior part of the apparatus through the air outlet, which is against the demand on low-noise of the projection apparatus.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention provides a projection apparatus and a thermal transfer module, which can lower noise generated by a fan, and have good heat dissipation efficiency.

Other objectives and advantages of the invention may be further understood from the technical features disclosed in the invention.

In order to achieve one, some, or all of the aforementioned objectives or other objectives, an embodiment of the invention provides a projection apparatus including a housing and at least one thermal transfer module, wherein the housing includes at least one air inlet and at least one air outlet. The thermal transfer module includes a flow-guiding structure, at least one fan, and at least one heat source. The flow-guiding structure is configured in the housing, and connected between the air inlet and the air outlet to form a flow channel. The fan is configured in the flow channel. The heat source is configured in the flow channel. The heat source is partially located between the fan and the air outlet.

In order to achieve one, some, or all of the aforementioned objectives or other objectives, an embodiment of the invention provides a thermal transfer module, including a flow-guiding structure, at least one fan, and at least one heat source. The flow-guiding structure forms a flow channel, where the flow channel includes at least one air inlet end and at least one air outlet end. The fan is configured in the flow channel. The heat source is configured in the flow channel. The heat source is partially located between the fan and the air outlet end.

In order to achieve one, some, or all of the aforementioned objectives or other objectives, an embodiment of the invention provides that a projection apparatus comprises a housing, a projection lens, a first fan, a second fan, and a transfer module. The housing comprises an air inlet and two air outlets. The air inlet is disposed on a bottom wall of the housing. The two air outlets are disposed on two side walls respectively, the two side walls are opposite to each other. The projection lens is configured in the housing. The first fan and the second fan are configured in the housing. The transfer module comprises a flow-guiding structure and a fan. The flow-guiding structure is configured in the housing. The flow-guiding structure connects between the air inlet and the air outlet to form a flow channel. The fan is configured in the flow channel. A heat dissipation airflow generated by the fan passes through the air inlet to the projection apparatus inside. The air inlet and the fan are disposed below the projection lens. The inlet and the fan are disposed between the first fan and the second fan. The inlet and the fan are between the two air outlets.

Based on the above, the embodiments of the invention include at least the following one advantage or effectiveness. In the projection apparatus in the embodiments of the invention, the heat source is located between the fan and the air outlet of the housing, so that the fan is not directly adjacent to the air outlet. In this way, noise generated by the fan is not directly transferred through the air outlet to an exterior part of the projection apparatus, and the noise is lowered to an extent because of blocking of the heat source and a distance between the fan and the air outlet. In addition, in the embodiments of the invention, the flow channel constituted by the flow-guiding structure is connected between the air inlet and the air outlet of the housing, and the fan and the heat source are accommodated in the flow channel. In this way, the heat dissipation airflow generated by the fan is limited by the flow-guiding structure to be in the flow channel, and can sequentially pass the air inlet, the fan, the heat source and the air outlet along the flow channel, thereby preventing the heat dissipation airflow from flowing along an unexpected path, and ensuring that the projection apparatus and the thermal transfer module have good heat dissipation efficiency.

Other objectives, features and advantages of the invention will be further understood from the further technological features disclosed by the embodiments of the invention where there are shown and described preferred embodiments of this invention, simply by way of illustration of modes best suited to carry out the invention.

### BRIEF DESCRIPTION OF THE DRAWINGS

In order to make the aforementioned and other objectives and advantages of the invention comprehensible, embodiments accompanied with figures are described in detail below.

FIG. 1 is a schematic plan view of a part of a structure of a projection apparatus according to an embodiment of the invention.

FIG. 2A is a schematic front view of a part of a structure of the projection apparatus in FIG. 1.

FIG. 2B is a schematic front view of a part of a structure of a projection apparatus according to another embodiment of the invention.

FIG. 3 is a schematic rear view of the part of the structure of the projection apparatus in FIG. 1.

FIG. 4 is a partially enlarged view of a thermal transfer module in FIG. 1.

FIG. 5A is a front view of a part of a structure of a projection apparatus according to another embodiment of the invention.

FIG. 5B is a front view of a part of a structure of a projection apparatus according to another embodiment of the invention.

FIG. 6 is a schematic front view of a part of a structure of a projection apparatus according to another embodiment of the invention.

FIG. 7A is a schematic side view of a part of a structure of a projection apparatus according to another embodiment of the invention.

FIG. 7B is a schematic side view of a part of a structure of a projection apparatus according to another embodiment of the invention.

FIG. 8 is a schematic plan view of a part of a structure of a projection apparatus according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “including”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive

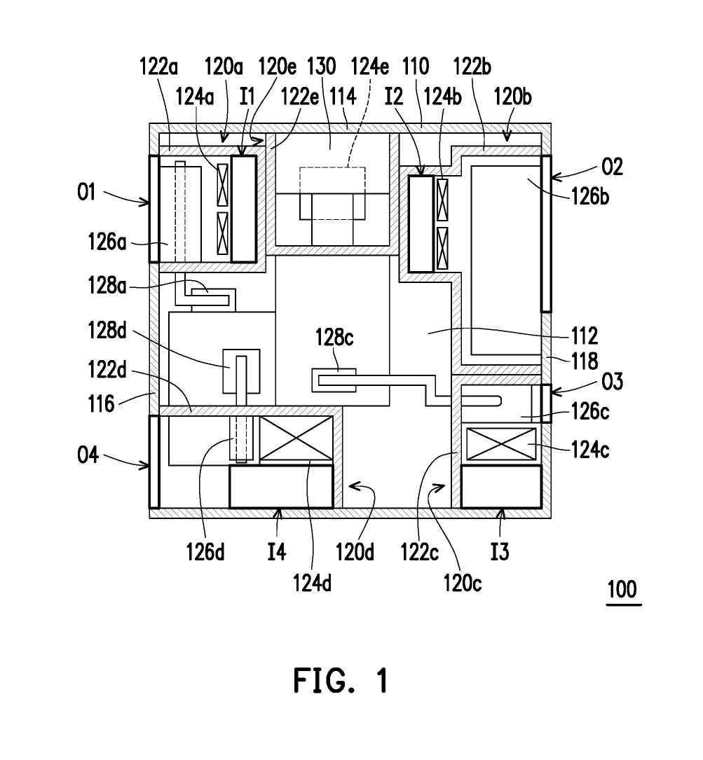

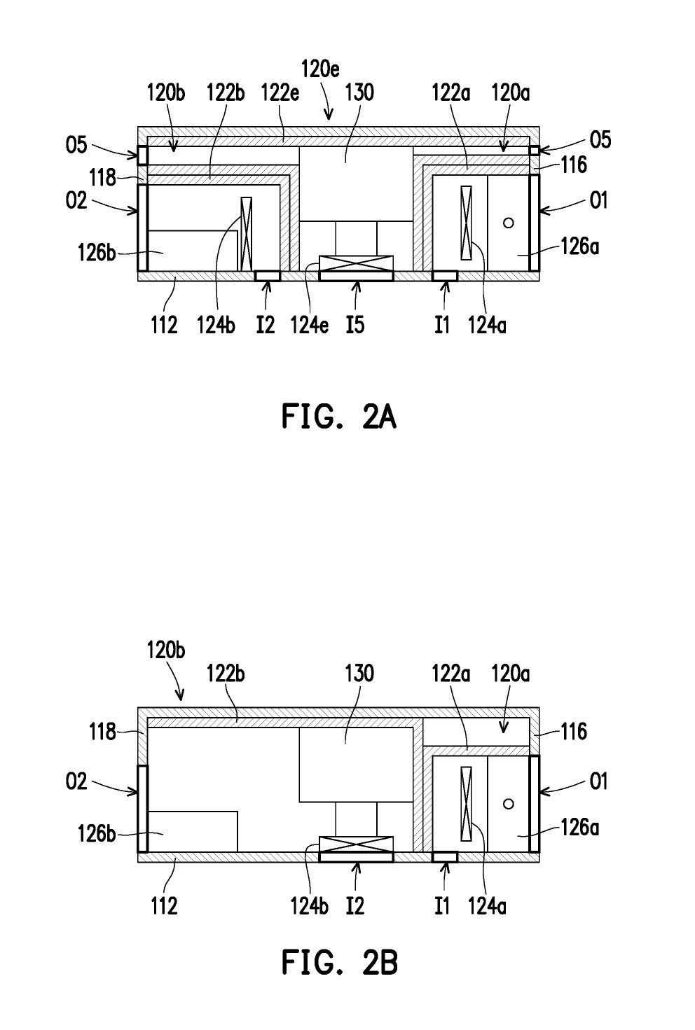

FIG. 1 is a schematic plan view of a part of a structure of a projection apparatus according to an embodiment of the invention. FIG. 2A is a schematic front view of a part of a structure of the projection apparatus in FIG. 1. Referring to FIG. 1 and FIG. 2A, the projection apparatus 100 in the embodiment includes a housing 110 and at least one thermal transfer module (five thermal transfer modules 120a, 120b, 120c, 120d, and 120e are shown as examples). In the embodiment, the housing 110 is an appearance part of the projection apparatus 100. The housing 110 includes at least one air inlet (five air inlets I1, I2, I3, I4, and I5 are shown as examples), and at least one air outlet (four air outlets O1, O2, O3, and O4 and two air outlets O5 are shown as examples).

In the embodiment, the thermal transfer modules may be respectively at least some partition blocks in the projection apparatus 100, or at least some partition blocks of an optical engine (optical engine), an optical module, an optoelectronic module, or an electronic module of the projection apparatus. Alternatively, the thermal transfer module may be an optical engine, an optical module, an optoelectronic module, or an electronic module. Specifically, in the embodiment, the air inlets I1, I2, I3, I4, and I5 correspond to the thermal transfer modules 120a, 120b, 120c, 120d, and 120e respectively. In the embodiment, heat dissipation airflows formed by environmental air outside the projection apparatus 100 respectively pass through the thermal transfer modules 120a, 120b, 120c, 120d, and 120e after the heat dissipation airflows enter the air inlets I1, I2, I3, I4, and I5. In addition, in the embodiment, the air outlets O1, O2, O3, O4, and O5 correspond to the thermal transfer modules 120a, 120b, 120c, 120d, and 120e respectively. In the embodiment, the heat dissipation airflows pass through the thermal transfer modules 120a, 120b, 120c, 120d, and 120e, and flow out of the housing 110 of the projection apparatus 100 through the air outlets O1, O2, O3, O4, and O5 respectively.

Specifically, referring to FIG. 1 and FIG. 2A, in the embodiment, the thermal transfer module 120a includes a flow-guiding structure 122a, at least one fan 124a (two fans of FIG. 2A are shown as examples), and a heat source 126a. In the embodiment, the flow-guiding structure 122a is configured in the housing 110, and is connected between the air inlet I1 and the air outlet O1, to form a flow channel. In the embodiment, the flow channel includes at least one air inlet end (one is shown as an example), and at least one air outlet end (one is shown as an example). The air inlet end and the air outlet end may respectively overlap, be connected to, or be adjacent to the air inlet I1 and the air outlet O1. Overlapping indicates that a position of the air inlet end is the same as that of the air inlet I1, and a position of the air outlet end is the same as that of the air outlet O1. In the embodiment, the fan 124a is configured in the flow channel. In the embodiment, the heat source 126a is, for example, a heat dissipation structure (such as a heat dissipation fin set), and is configured in the flow channel, and is at least partially located between the fan 124a and the air outlet O1. In the embodiment, projection apparatus 100 may further include a heat generating element 128a. In the embodiment, the heat generating element 128a is, for example, a light source (such as at least one light emitting diode, a laser diode or a laser diode array, but the invention is not limited thereto), and is connected to the heat dissipation structure. Heat generated by the heat generating element 128a may be transferred to the heat dissipation structure, and heat dissipation airflows generated by the fan 124a are used to dissipate the heat of the heat dissipation structure. Briefly, in the embodiment, the heat generating element 128a may be connected to the heat source 126a, and the heat dissipation airflows generated by the fan 124a may dissipate the heat of the heat source 126a.

Similarly, referring to FIG. 1 and FIG. 2A, in the embodiment, the thermal transfer module 120b includes a flow-guiding structure 122b, at least one fan 124b (two fans of FIG. 2A are shown as examples), and a heat source 126b. In the embodiment, the flow-guiding structure 122b is configured in the housing 110, and is connected between the air inlet I2 and the air outlet O2, to form a flow channel. In the embodiment, the flow channel includes at least one air inlet end (one is shown as an example), and at least one air outlet end (one is shown as an example). The air inlet end and the air outlet end may respectively overlap, be connected to, or be adjacent to the air inlet I2 and the air outlet O2. Overlapping indicates that a position of the air inlet end and a position of the air outlet end are respectively the same as a position of the air inlet I2 and a position of the air outlet O2. In the embodiment, the fan 124b is configured in the flow channel. In the embodiment, heat source 126b is, for example, a power supply element, and is configured in the flow channel, and is at least partially located between the fan 124b and the air outlet O2. In the embodiment, heat dissipation airflows generated by the fan 124b are used to dissipate heat of the power supply element (the heat source 126b).

Similarly, referring to FIG. 1 and FIG. 2A, in the embodiment, the thermal transfer module 120e includes a flow-guiding structure 122e, at least one fan 124e (one is shown as an example), and a heat source. In the embodiment, the heat source of the thermal transfer module 120e is a projection lens 130 of the projection apparatus 100. In the embodiment, the flow-guiding structure 122e is configured in the housing 110, and is connected between the air inlet I5 and the air outlet O5, to form a flow channel. In the embodiment, the flow channel includes at least one air inlet end (one is shown as an example), and at least one air outlet end (one is shown as an example). The air inlet end and the air outlet end may respectively overlap, be connected to, or adjacent to the air inlet I5 and the air outlet O5. Overlapping indicates that a position of the air inlet end and a position of the air outlet end are respectively the same as a position of the air inlet I5 and a position of the air outlet O5. In the embodiment, the fan 124e is configured in the flow channel. In the embodiment, the projection lens 130 is configured in the flow channel, and is at least partially located between the fan 124e and the air outlet O5. In the embodiment, heat dissipation airflows generated by fan 124e are used to dissipate heat of the projection lens 130 (that is, the heat source in the thermal transfer module 120e). Heat generated by an image beam on the projection lens 130 when projection is performed needs to be dissipated by using the fan 124e of thermal transfer module 120e. In the embodiment, there are two air outlets O5, as shown in FIG. 2A. However, the invention is not limited thereto, and there may be one air outlet O5.

Referring to FIG. 1 and FIG. 2A. In the embodiment, the air inlet I5 and the fan 124e are disposed below the projection lens 130. Meanwhile, the projection lens 130, the air inlet I5, and the fan 124e are disposed between the two fans 124a, 124b and between the two air outlets O1, O2. The heat dissipation airflow generated by the fan 124e passes through the air inlet I5 to the interior of the projection apparatus 100. The heat dissipation airflow passed through the fan 124e is divided into three parts. One part of the heat dissipation airflow flows to the projection lens 130. One part of the heat dissipation airflow flows and passes the thermal transfer module 120b, and then heat dissipation airflow flows out of the projection apparatus 110 via one of the air outlets O2, O3 or O5. One part of the heat dissipation airflow flows and passes the thermal transfer module 120a, and then heat dissipation airflow flows out of the projection apparatus 110 via one of the air outlets O1, O4 or O5.

Based on the above, in other embodiments, the thermal transfer module may include a plurality of heat sources, as shown in FIG. 2B. FIG. 2B is a schematic front view of a part of a structure of a projection apparatus according to another embodiment of the invention. The embodiment shown in FIG. 2B is different from that shown in FIG. 2A in that the thermal transfer module 120b in FIG. 2B includes two heat sources: the heat source 126b (such as a power supply element, but is not limited thereto), and the projection lens 130. More specifically, in the embodiment of the thermal transfer module 120b in FIG. 2B, the flow-guiding structure 122b extends toward the projection lens 130, to wrap the projection lens 130, the fan 124b is aligned with (align) the projection lens 130, and the air inlet I2 is aligned with the fan 124b. Briefly, in FIG. 2B, the heat source 126b and the projection lens 130 are, for example, located in a same thermal transfer module 120b.

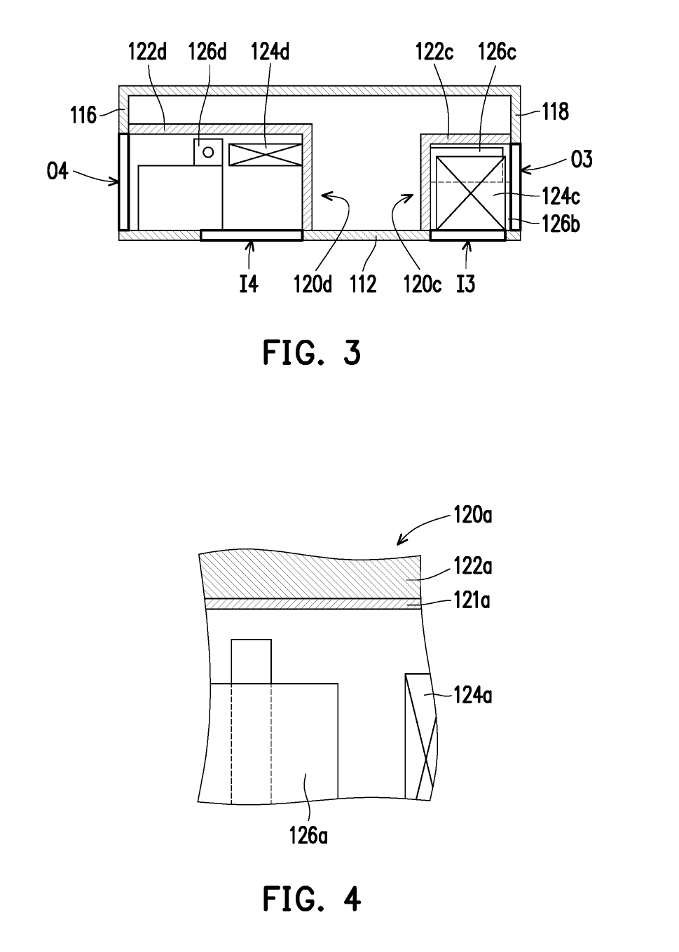

The thermal transfer modules 120c and 120d in FIG. 1 are similar to the thermal transfer module 120a and 120b in the foregoing FIG. 2A. Specifically, referring to FIG. 1 and FIG. 3, FIG. 3 is a schematic rear view of the part of the structure of the projection apparatus in FIG. 1. In the embodiment, the thermal transfer module 120c includes a flow-guiding structure 122c, at least one fan 124c (one is shown as an example), and a heat source 126c. In the embodiment, the flow-guiding structure 122c is configured in the housing 110, and is connected between the air inlet I3 and the air outlet O3, to form a flow channel. In the embodiment, the flow channel includes at least one air inlet end (one is shown as an example), and at least one air outlet end (one is shown as an example). The air inlet end and the air outlet end may respectively overlap, be connected to, or be adjacent to the air inlet I3 and the air outlet O3. Overlapping indicates that a position of the air inlet end and a position of the air outlet end are respectively the same as a position of the air inlet I3 and a position of the air outlet O3. In the embodiment, the fan 124c is located in the flow channel. In the embodiment, the heat source 126c is a heat dissipation structure (such as a heat dissipation fin set), and is configured in the flow channel, and is at least partially located between the fan 124c and the air outlet O3. In the embodiment, the projection apparatus 100 may further include a heat generating element 128c. In the embodiment, heat generating element 128c is, for example, a light valve (such as a digital micromirror device (DMD), a liquid crystal display (LCD), a liquid crystal on silicon (Lcos)), and is connected to the heat dissipation structure. Heat generated by heat generating element 128c may be transferred to the heat dissipation structure, and heat dissipation airflows generated by the fan 124c are used to dissipate the heat of the heat dissipation structure. Briefly, in the embodiment, the heat generating element 128c may be connected to the heat source 126c, and the heat dissipation airflows generated by the fan 124c can dissipate the heat of heat source 126c.

Similarly, referring to FIG. 1 and FIG. 3, in the embodiment, the thermal transfer module 120d includes a flow-guiding structure 122d, at least one fan 124d (one is shown as an example), and a heat source 126d. In the embodiment, the flow-guiding structure 122d is configured in the housing 110, and is connected between the air inlet I4 and the air outlet O4, to form a flow channel. In the embodiment, the flow channel includes at least one air inlet end (one is shown as an example), and at least one air outlet end (one is shown as an example). The air inlet end and the air outlet end may respectively overlap, be connected to, or be adjacent to the air inlet I4 and the air outlet O4. Overlapping indicates that a position of the air inlet end and a position of the air outlet end are respectively the same as a position of the air inlet I4 and a position of the air outlet O4. In the embodiment, the fan 124d is configured in the flow channel. In the embodiment, the heat source 126d is, for example, a heat dissipation structure (such as a heat dissipation fin set), and is configured in the flow channel, and is at least partially located between the fan 124d and the air outlet O4. In the embodiment, the projection apparatus 100 may further include a heat generating element 128d. In the embodiment, the heat generating element 128d is, for example, an optical wavelength converter (such as a phosphor wheel), and is connected to the heat dissipation structure. Heat generated by the heat generating element 128d may be transferred to the heat dissipation structure, and heat dissipation airflows generated by the fan 124d are used to dissipate the heat of the heat dissipation structure. Briefly, in the embodiment, the heat generating element 128d may be connected to the heat source 126d, and the heat dissipation airflows generated by the fan 124d can dissipate the heat of the heat source 126d.

In other embodiments that are not shown, the heat source may be, in addition to the foregoing described heat dissipation structure, projection lens or power supply element, at least one of a light source, a light valve, and a wavelength converter, and is not limited in the invention. That is, in other embodiments, the thermal transfer module may include at least one of a light source, a light valve, and an optical wavelength converter. The heat dissipation airflows generated by the fan can dissipate heat of the heat source (at least one of a light source, a light valve, and an optical wavelength converter).

In the foregoing configuration manner, the heat source 126a (or the heat source 126b, 126c, 126d, or the projection lens 130) is located between the fan 124a (or the fan 124b, 124c, 124d, or 124e) and the air outlet O1 (or the air outlet O2, O3, O4, or O5) of the housing 110, so that the fan 124a (or the fan 124b, 124c, 124d, or 124e) may not be directly adjacent to the air outlet O1 (or the air outlet O2, O3, O4, or O5). In this way, noise generated by the fan 124a (or the fan 124b, 124c, 124d, or 124e) is not directly transferred to the exterior part of the projection apparatus 100 through the air outlet O1 (or the air outlet O2, O3, O4, or O5), and the noise can be lowered because of blocking of a physical ground of the heat source 126a (or the heat source 126b, 126c, 126d, or the projection lens 130) and a distance between the fan 124a (or the fan 124b, 124c, 124d, or 124e) and the air outlet O1 (or the air outlet O2, O3, O4, or O5). In addition, the flow channel constituted by the flow-guiding structure 122a (or the flow-guiding structure 122b, 122c, 122d, or 122e) is connected between the air inlet I1 (or the air inlet I2, I3, I4, or I5) and the air outlet O1 (or air outlet O2, O3, O4, or O5) of the housing 110, and the fan 124a (or the fan 124b, 124c, 124d, or 124e) and the heat source 126a (or the heat source 126b, 126c, 126d, or the projection lens 130) are accommodated in the flow channel, so that the heat dissipation airflows generated by the fan 124a (or the fan 124b, 124c, 124d, or 124e) is limited by the flow-guiding structure 122a (or the flow-guiding structure 122b, 122c, 122d, or 122e) to sequentially pass, along the flow channel, the air inlet I1 (or the air inlet I2, I3, I4, or I5), the fan 124a (or the fan 124b, 124c, 124d, or 124e), the heat source 126a (or the heat source 126b, 126c, 126d, or the projection lens 130), and the air outlet O1 (or the air outlet O2, O3, O4, or O5), thereby preventing the heat dissipation airflows from flowing along an unexpected path, and ensuring that the projection apparatus 100 and the thermal transfer module 120a (or the thermal transfer module 120b, 120c, 120d, or 120e) have good heat dissipation efficiency.

In the embodiment, referring to FIG. 1, FIG. 2A and FIG. 3, the housing 110 has a plurality of surfaces, that is, a first wall surface 112 (such as a bottom wall), a second wall surface 114 (such as a first side wall), a third wall surface 116 (such as a second side wall), and a fourth wall surface 118 (such as a third side wall). In the embodiment, the second wall surface 114 is adjacent between the third wall surface 116 and the fourth wall surface 118. The third wall surface 116 is opposite to the fourth wall surface 118. In the embodiment, the first wall surface 112 is perpendicular to the second wall surface 114, the third wall surface 116, and the fourth wall surface 118. However, the invention in not limited thereto. In other embodiments, the first wall surface 112 may be neither perpendicular to nor parallel with the second wall surface 114. In some embodiments, the first wall surface 112 may be neither perpendicular to nor parallel with the third wall surface 116. In some embodiments, the first wall surface 112 may be neither perpendicular to nor parallel with the fourth wall surface 118. In the embodiment, the air inlets I1, I2, I3, I4, and I5 are formed on the first wall surface 112 of the housing 110, to be respectively adjacent to the fans 124a, 124b, 124c, 124d, and 124e. The air outlets O1, O4, and O5 are formed on the third wall surface 116 of the housing 110, and the air outlets O2, O3, and O5 are formed on the fourth wall surface 118 of the housing 110, to exhaust waste heat. In the embodiment, the fans 124a, 124b, 124c, and 124d are respectively aligned with the air outlets O1, O2, O3, and O4, to enable heat dissipation airflows to pass through the heat sources 126a, 126b, 126c, and 126d, and then be exhausted to the exterior part of the projection apparatus 100 through the air outlets O1, O2, O3, and O4. In addition, in the embodiment, the projection lens 130 is adjacent to the second wall surface 114. For example, the projection lens 130 is adjacent to the second wall surface 114 and protrudes from the second wall surface 114, to project an image beam. The air outlets O1, O4, and O5 are formed on the third wall surface 116 of the housing 110, and the air outlets O2, O3, and O5 are formed on the fourth wall surface 118 of the housing 110, to exhaust waste heat.

However, in other embodiments, a fan is not aligned with an air outlet. For example, in the embodiments in FIG. 2A and FIG. 2B, the fan 124e corresponds to (corresponding) the air outlet O1, and a distance in a horizontal direction between the fan 124e and the air outlet O1 is, for example, less than or equal to half a length of the first wall surface 112 in the horizontal direction. In some embodiments that are not shown, a fan corresponds to an air outlet, and a distance in a horizontal direction between the fan and air outlet is, for example, greater than or equal to half a length of the first wall surface 112 in the horizontal direction. However, the invention is still not limited to the foregoing embodiments.

FIG. 4 is a partially enlarged view of the thermal transfer module in FIG. 1. Referring to FIG. 4, the thermal transfer module 120a in the embodiment includes a sound-absorbing layer 121a. The sound-absorbing layer 121a is configured in the flow-guiding structure 122a, to lower the noise that is transferred to an exterior part when the fan 124a is operated. Similarly, in the embodiment, the thermal transfer modules 120b, 120c, 120d, and 120e may be respectively configured in sound-absorbing layers in the flow-guiding structures 122b, 122c, 122d, and 122e, to lower noise that is transferred to the exterior part when the fans 124b, 124c, 124d, and 124e are operated. In the embodiment, the sound-absorbing layer may be a sound-absorbing cotton, a sound-absorbing rubber layer, or other suitable materials, and is not limited in the invention.

In the foregoing embodiment, the flow-guiding structure 122a, 122b, 122c, 122d, or 122e is, for example, a cover body connected between the air inlet I1, I2, I3, I4, or I5 and the air outlet O1, O2, O3, O4, or O5. Specifically, in the embodiment in FIG. 1 and FIG. 2A, the flow-guiding structure 122a is, for example, a cover body. The cover body is connected to the air inlet I1, and extends toward the air outlet O1 and is connected to the air outlet O1. That is, the cover body is connected to the air outlet O1, and extends toward the air inlet I1 and is connected to the air inlet I1. Similarly, in the embodiment in FIG. 1 and FIG. 2A, the flow-guiding structure 122b is, for example, a cover body. The cover body is connected to the air inlet I2, and extends toward the air outlet O2 and is connected to the air outlet O2. That is, the cover body is connected to the air outlet O2, and extends toward the air inlet I2 and is connected to the air inlet I2. Similarly, in the embodiment in FIG. 1 and FIG. 2A, the flow-guiding structure 122e is, for example, a cover body. The cover body is connected to the air inlet I5, and extends toward the air outlet O5 and is connected to the air outlet O5. That is, the cover body is connected to the air outlet O5, and extends toward the air inlet I5 and is connected to the air inlet I5. Similarly, in the embodiments in FIG. 1 and FIG. 2B, the flow-guiding structure 122b is, for example, a cover body. The cover body is connected to the air inlet I2, and extends toward the air outlet O2 and is connected to the air outlet O2. That is, the cover body is connected to the air outlet O2, and extends toward the air inlet I2 and is connected to the air inlet I2. Similarly, in the embodiment in FIG. 1 and FIG. 3, the flow-guiding structure 122c is, for example, a cover body. The cover body is connected to the air inlet I3, and extends toward the air outlet O3 and is connected to the air outlet O3. That is, the cover body is connected to the air outlet O3, and extends toward the air inlet I3 and is connected to the air inlet I3. Similarly, in the embodiment in FIG. 1 and FIG. 3, the flow-guiding structure 122d is, for example, a cover body. The cover body is connected to the air inlet I4, and extends toward the air outlet O4 and is connected to the air outlet O4. That is, the cover body is connected to the air outlet O4, and extends toward the air inlet I4 and is connected to the air inlet I4.

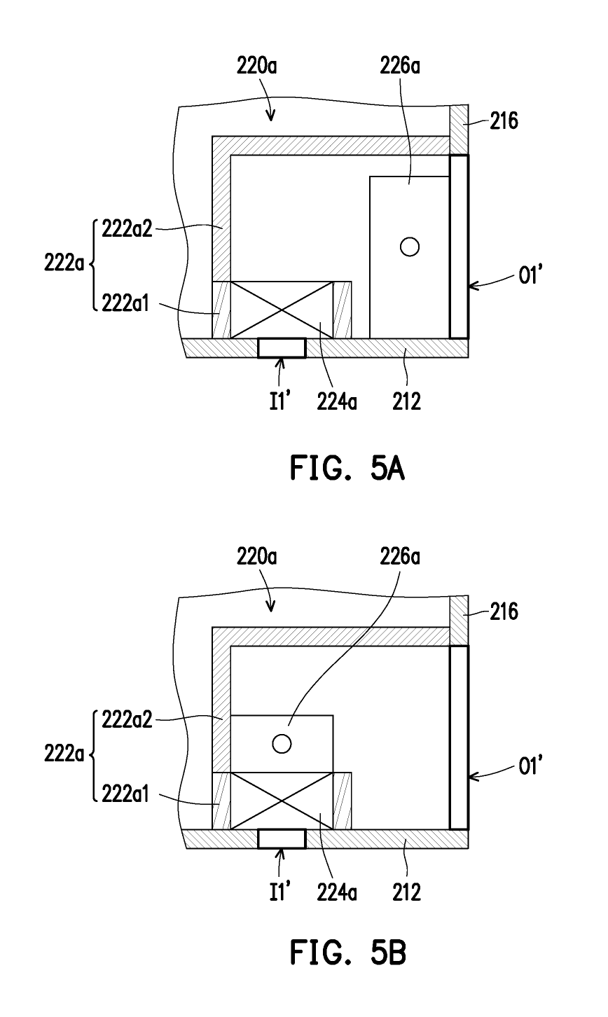

In other embodiments, the flow-guiding structure may be a structure of another form, and is described below by example and with reference to accompanying drawings. FIG. 5A is a front view of a part of a structure of a projection apparatus according to another embodiment of the invention. In the embodiment shown in FIG. 5A, configuration and acting manners of a first wall surface 212, a third wall surface 216, an air inlet I1′, an air outlet O1′, a thermal transfer module 220a, a flow-guiding structure 222a, a fan 224a, and a heat source 226a are similar to those of the first wall surface 112, the third wall surface 116, the air inlet I1, the air outlet O1, the thermal transfer module 120a, the flow-guiding structure 122a, the fan 124a, and the heat source 126a in FIG. 2A, and the descriptions thereof are omitted herein. Major differences between the thermal transfer module 220a and the thermal transfer module 120a are: The fan 224a is adjacent to the air inlet I1′; the flow-guiding structure 222a includes a shell body 222a1 and a cover body 222a2; the shell body 222a1 wraps the fan 224a; the cover body 222a2 is connected to the shell body 222a1, and extends toward a direction of the air outlet O1′ and is connected to the air outlet O1′. That is, a housing (that is, the shell body 222a1) of the fan 224a is a part of the flow-guiding structure 222a.

FIG. 5B is a front view of a part of a structure of a projection apparatus according to another embodiment of the invention. A major difference between the embodiment shown in FIG. 5B and that shown in FIG. 5A is that, unlike in FIG. 5A, the heat source 226a in FIG. 5B is not adjacent to the air outlet O1′. Specifically, in the embodiment in FIG. 5B, the heat source 226a is separate from the air outlet O1′, and the heat source 226a is stacked on the fan 224a. However, the invention is still not limited thereto.

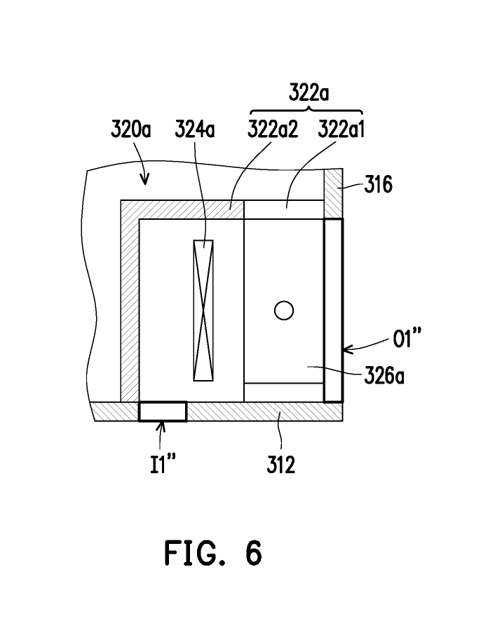

FIG. 6 is a schematic front view of a part of a structure of a projection apparatus according to another embodiment of the invention. In the embodiment shown in FIG. 6, configuration and acting manners of a first wall surface 312, a third wall surface 316, an air inlet I1″, an air outlet O1″, a thermal transfer module 320a, a flow-guiding structure 322a, a fan 324a, and a heat source 326a are similar to those of the first wall surface 112, the third wall surface 116, the air inlet I1, the air outlet O1, the thermal transfer module 120a, the flow-guiding structure 122a, the fan 124a, and the heat source 126a in FIG. 2A, and the descriptions thereof are omitted herein. Major differences between the thermal transfer module 320a and the thermal transfer module 120a are: The heat source 326a is directly adjacent to the air outlet O1″; the flow-guiding structure 322a includes a baffle wall 322a1 and a cover body 322a2; the baffle wall 322a1 protrudes from the heat source 326a; the cover body 322a2 is connected to the baffle wall 322a1, and extends toward the air inlet I1″ and is connected to the air inlet I1″. Specifically, in the embodiment shown in FIG. 6, the heat source 326a is, for example, a heat dissipation fin set. The heat dissipation fin set includes a plurality of heat dissipation fins. Each heat dissipation fin includes a folded wall. The folded wall of the heat dissipation fin set constitutes the baffle wall 322a1 of the flow-guiding structure 322a, and becomes a part of the flow-guiding structure 322a.

However, in other embodiments that are not shown, a design in FIG. 5B and that in FIG. 6 may be combined. That is, a flow-guiding structure may be jointly constituted by a housing of a fan, a cover body and a folded wall of a heat dissipation fin set, but is still not limited in the invention.

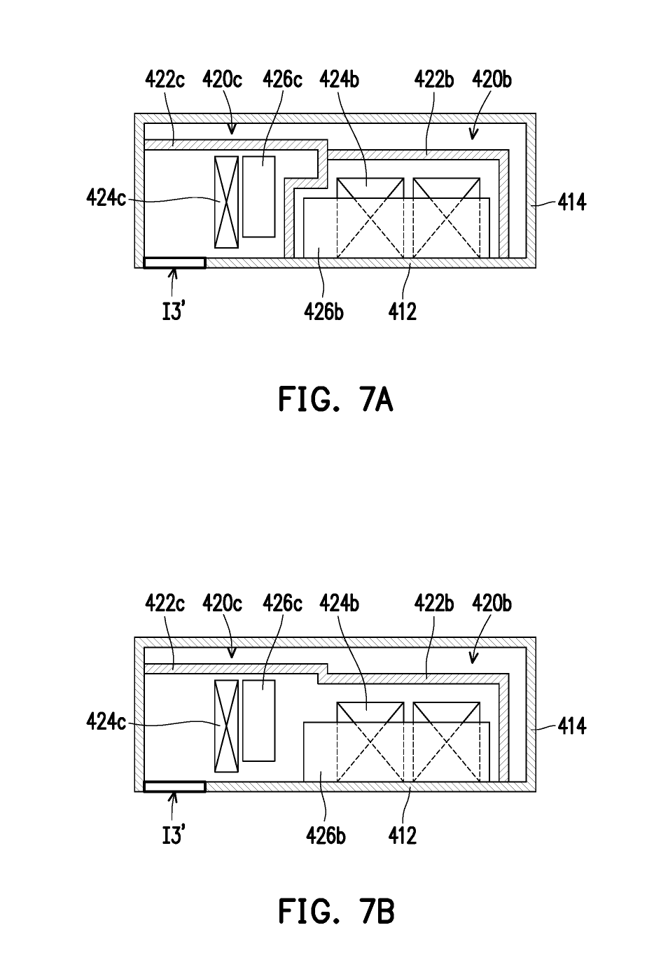

FIG. 7A is a schematic side view of a part of a structure of a projection apparatus according to another embodiment of the invention. In the embodiment shown in FIG. 7A, configuration and acting manners of a first wall surface 412, a second wall surface 414, an air inlet I3′, a thermal transfer module 420b,a flow-guiding structure 422b, a fan 424b, a heat source 426b, a thermal transfer module 420c, a flow-guiding structure 422c, a fan 424c, and a heat source 426c are similar to those of the first wall surface 112, the second wall surface 114, the air inlet I3, the thermal transfer module 120b, the flow-guiding structure 122b, the fan 124b, the heat source 126b, the thermal transfer module 120c, the flow-guiding structure 122c, the fan 124c, and the heat source 126c in FIG. 1, and the descriptions thereof are omitted herein. Major differences between the embodiment shown in FIG. 7A and that shown in FIG. 1 to FIG. 3 are: The heat source 426b of the thermal transfer module 420b and a flow channel constituted by the flow-guiding structure 422b at least partially overlap the heat source 426c of another thermal transfer module 420c and a flow channel constituted by the flow-guiding structure 422c in a direction perpendicular to the first wall surface 412 (that is, a direction parallel with the second wall surface 414 in the embodiment). That is, in the embodiment shown in FIG. 7A, the heat source 426b and the heat source 426c are at least partially and vertically stacked, and the flow channel constituted by the flow-guiding structure 422b and the flow channel constituted by the flow-guiding structure 422c are vertically stacked. In addition, in other embodiments that are not shown, the heat source 426c may further be configured in a grove of the flow-guiding structure 422c that is above the heat source 426b in FIG. 7A (that is, the flow-guiding structure 422c in FIG. 7A has a groove in a joint between flow-guiding structure 422b and the flow-guiding structure 422c), to make the heat source 426b and the heat source 426c vertically stacked. In this way, a configuration space of the heat source and the flow channel may be reduced.

FIG. 7B is a schematic side view of a part of a structure of a projection apparatus according to another embodiment of the invention. A major difference between the embodiment shown in FIG. 7B and that shown in FIG. 7A is that the flow-guiding structure 422b and the flow-guiding structure 422c in FIG. 7B are in communication with each other.

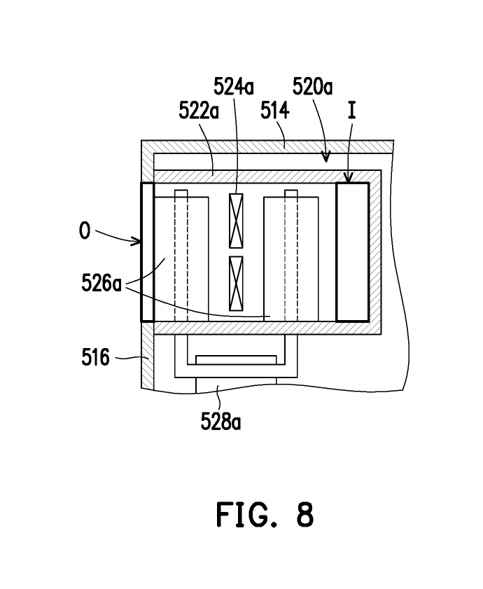

FIG. 8 is a schematic plan view of a part of a structure of a projection apparatus according to another embodiment of the invention. In the embodiment shown in FIG. 8, configuration and acting manners of a second wall surface 514, a third wall surface 516, an air inlet I, an air outlet O, a thermal transfer module 520a, a flow-guiding structure 522a, a fan 524a, a heat source 526a, and a heat generating element 528a are similar to those of the second wall surface 114, the third wall surface 116, the air inlet I1, the air outlet O1, the thermal transfer module 120a, the flow-guiding structure 122a, the fan 124a, the heat source 126a, and the heat generating element 128a in FIG. 1, and the descriptions thereof are omitted herein. Major differences between the embodiment shown in FIG. 8 and that shown in FIG. 1 are: The heat source 526a includes two heat dissipation fin sets, and the two heat dissipation fin sets are respectively configured on two opposite sides of the fan 524a, so as to further improve heat dissipation efficiency. That is, a part of the heat source 526a is located between the air outlet O and the fan 524a, and the other part of the heat source 526a is located between the air inlet I and the fan 524a.

Based on the above, the embodiments of the invention include at least the following one advantage or effectiveness. In the projection apparatus in the embodiments of the invention, the heat source is located between the fan and the air outlet of the housing, so that the fan is not directly adjacent to the air outlet. In this way, noise generated by the fan is not directly transferred to an exterior part of the projection apparatus through the air outlet, and does not affect a user. Further, the noise may be lowered because of blocking of the heat source and a distance between the fan and the air outlet. In addition, in the embodiments of the invention, the flow channel constituted by the flow-guiding structure is connected between the air inlet the air outlet of the housing, and the fan and the heat source are accommodated in the flow channel, so that heat dissipation airflows generated by the fan is limited by the flow-guiding structure to be in the flow channel, and to sequentially pass the air inlet, the fan, the heat source, and the air outlet along the flow channel, thereby preventing the heat dissipation airflow from flowing along an unexpected path, and ensuring that the projection apparatus and the thermal transfer module have good heat dissipation efficiency.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A projection apparatus, comprising:
a housing, comprising at least one air inlet and at least one air outlet; and
at least one thermal transfer module, comprising:
a flow-guiding structure, configured in the housing, and connected between the air inlet and the air outlet to form a flow channel;
at least one fan, configured in the flow channel; and
at least one heat source, configured in the flow channel, wherein the at least one heat source is partially located between the fan and the air outlet.

2. The projection apparatus according to claim 1, wherein the fan is aligned with the air outlet.

3. The projection apparatus according to claim 1, wherein the fan is adapted to generate a heat dissipation airflow, and the flow-guiding structure limits the heat dissipation airflow to sequentially pass the air inlet, the fan, the heat source and the air outlet along the flow channel.

4. The projection apparatus according to claim 1, wherein the housing comprises a bottom wall and at least one side wall, the air inlet is formed on the bottom wall, the air outlet is formed on the side wall, and the bottom wall is not parallel with the side wall.

5. The projection apparatus according to claim 1, wherein the flow-guiding structure comprises a cover body, and the cover body is connected to the air inlet and extends toward the air outlet.

6. The projection apparatus according to claim 1, wherein the fan is adjacent to the air inlet, and the flow-guiding structure comprises a shell body and a cover body, the shell body wraps the fan, and the cover body is connected to the shell body and extends toward the air outlet.

7. The projection apparatus according to claim 1, wherein the flow-guiding structure comprises a cover body, and the cover body is connected to the air outlet and extends toward the air inlet.

8. The projection apparatus according to claim 1, wherein the heat source is adjacent to the air outlet, and the flow-guiding structure comprises a baffle wall and a cover body, the baffle wall extends from the heat source, and the cover body is connected to the baffle wall and extends toward the air inlet.

9. The projection apparatus according to claim 8, wherein the heat source comprises a heat dissipation fin set, the heat dissipation fin set comprises a plurality of heat dissipation fins, each of the heat dissipation fins comprises a folded wall, and the folded wall constitutes the baffle wall.

10. The projection apparatus according to claim 1, further comprising a projection lens, wherein the housing comprises a first wall surface, a second wall surface, a third wall surface and a fourth wall surface, the first wall surface is connected to the second wall surface, the third wall surface and the fourth wall surface, the second wall surface is connected between the third wall surface and the fourth wall surface, the third wall surface is opposite to the fourth wall surface, the number of the at least one air outlet and the number of the at least one air inlet are multiple, the air inlets are configured on the first wall surface, the projection lens is adjacent to the second wall surface, and the air outlets are configured on the third wall surface and the fourth wall surface.

11. The projection apparatus according to claim 1, further comprising a heat generating element, wherein the heat source is a heat dissipation structure, and the heat generating element is connected to the heat dissipation structure.

12. The projection apparatus according to claim 1, wherein the heat source comprises at least one of a light source, a light valve, an optical wavelength converter, a projection lens, and a power supply element.

13. The projection apparatus according to claim 1, wherein the number of the at least one air inlet is multiple, the number of the at least one air outlet is multiple, the number of the at least one thermal transfer module is multiple, and the thermal transfer modules respectively correspond to the air inlets and respectively correspond to the air outlets.

14. The projection apparatus according to claim 13, wherein the housing comprises a bottom wall and at least one side wall perpendicular to each other, the air outlets are formed on the side wall, the heat source and the flow channel of one of the thermal transfer modules at least partially overlap the heat source and the flow channel of another one of the thermal transfer modules in a direction perpendicular to the bottom wall.

15. The projection apparatus according to claim 1, wherein the thermal transfer module comprises a sound-absorbing layer, and the sound-absorbing layer is configured in the flow-guiding structure.

16. The projection apparatus according to claim 1, wherein a part of the heat source is located between the air outlet and the fan, and the other part of the heat source is located between the air inlet and the fan.

17. A thermal transfer module, comprising:
a flow-guiding structure, forming a flow channel, wherein the flow channel comprises at least one air inlet end and at least one air outlet end;
at least one fan, configured in the flow channel; and
at least one heat source, configured in the flow channel, wherein the at least one heat source partially located between the fan and the air outlet end.

18. A projection apparatus, comprising:
a housing, comprising an air inlet and two air outlets, wherein the air inlet is disposed on a bottom wall of the housing, and the two air outlets are disposed on two side walls respectively, the two side walls are opposite to each other;
a projection lens, configured in the housing;
a first fan and a second fan, configured in the housing; and
a transfer module, comprising:
a flow-guiding structure, configured in the housing, and connected between the air inlet and the air outlet to form a flow channel; and
a fan, configured in the flow channel, wherein a heat dissipation airflow generated by the fan passes through the air inlet to the projection apparatus inside, and wherein the air inlet and the fan are disposed below the projection lens, the inlet and the fan are disposed between the first fan and the second fan, and between the two air outlets.
